(19) United States
(12) Patent Application Publication
(10) Pub. No.: US 2006/0285496 A1
(43) Pub. Date: Dec. 21, 2006

(54) Digital subscriber line user capacity estimation

(75) Inventor: Stuart Lynch Blackburn, San Ramon, CA (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno (US)

(21) Appl. No.: 11/513,084

(22) Filed: Aug. 30, 2006

Related U.S. Application Data
(63) Continuation-in-part of application No. 10/842,842, filed on May 11, 2004, now Pat. No. 7,123,584.
Application No. 10/842,842 is a continuation-in-part of application No. 10/766,314, filed on Jan. 28, 2004, now Pat. No. 7,126,914.

(51) Int. Cl. H04J 1/16; H04L 12/56

(52) U.S. Cl. 370/235; 370/395.1

(57) ABSTRACT

In a particular embodiment, the present disclosure is directed to a data communications system. The data communication system includes a plurality of digital subscriber lines, a digital subscriber line multiplexer coupled to each of the plurality of digital subscriber lines, and a data switch coupled to the digital subscriber line multiplexer via a communication link. The data communications system is configured such that the number of digital subscriber line users supported by the digital subscriber line multiplexer is determined based on an estimated maximum number of users, the estimated maximum number of users determined based on an average peak bandwidth per user value, a data communication capacity of the communication link, and a data transmission slowdown indicator. The communication capacity is based on a user type selected from a set of available user types.

### RELATED APPLICATIONS

The present application claims priority from and is a continuation of patent application Ser. No. 10/842,842 filed on May 11, 2004 and entitled “Digital Subscriber Line User Capacity Estimation,” which claims priority from and is a continuation-in-part of patent application Ser. No. 10/766,314 filed on Jan. 28, 2004 and entitled “Digital Subscriber Line User Capacity Estimation, both of which are incorporated herein in their entireties.

### FIELD OF THE DISCLOSURE

The present disclosure generally relates to data communication systems and methods of configuring a data network based on user capacity estimation techniques.

### BACKGROUND OF THE DISCLOSURE

Telecommunications providers of data services, such as digital subscriber line (DSL) service, utilize concentration equipment that support many individual lines. To configure such equipment in a manner to match the data needs of the subscribers connected thereto, it would be desirable to have a data transmission capacity model. With conventional methods, there is no good method of estimating the number of customers that can be served by a remote terminal or a digital subscriber line access multiplexer (DSLAM). A limiting factor in capacity is the connection between the remote terminal or the DSLAM and the ATM switch. Typically this connection is an OC3 or DS3 connection. In the event that the equipment is configured above a reasonable capacity, then customers receive a lower quality service and experience significant data slowdown.

Accordingly, there is a need for a method and system to estimate the number of customers that can be supported on deployed network equipment.

### BRIEF DESCRIPTION OF THE DRAWINGS

FIG. 1 is a general block diagram that illustrates a network with a remote terminal (RT) supporting residential subscribers.

FIG. 2 is a general block diagram that illustrates a network with a DSLAM supporting residential subscribers.

FIG. 3 is a flow chart that illustrates a method of estimating a maximum number of users of DSL lines supported by a DSLAM.

FIG. 4 is a flow chart that illustrates a method of estimating a maximum number of users of DSL lines supported by an RT unit.

FIG. 5 is a flow chart that illustrates another method of estimating a maximum number of users of DSL lines.

### DETAILED DESCRIPTION OF THE DRAWINGS

In a particular embodiment, the present disclosure is directed to a data communications system. The data communication system includes a plurality of digital subscriber lines, a digital subscriber line multiplexer coupled to each of the plurality of digital subscriber lines, and a data switch coupled to the digital subscriber line multiplexer via a communication link. The data communications system is configured such that the number of digital subscriber line users supported by the digital subscriber line multiplexer is determined based on an estimated maximum number of users, the estimated maximum number of users determined based on an average peak bandwidth per user value, a data communication capacity of the communication link, and a data transmission slowdown indicator. The communication capacity is based on a user type selected from a set of available user types. In a particular embodiment, the estimated maximum number of users of digital subscriber lines is calculated with an assumption that a first set of users of the first user type download data at the same data transfer speed and a second set of user having a second user type download data at a different data transfer speed.

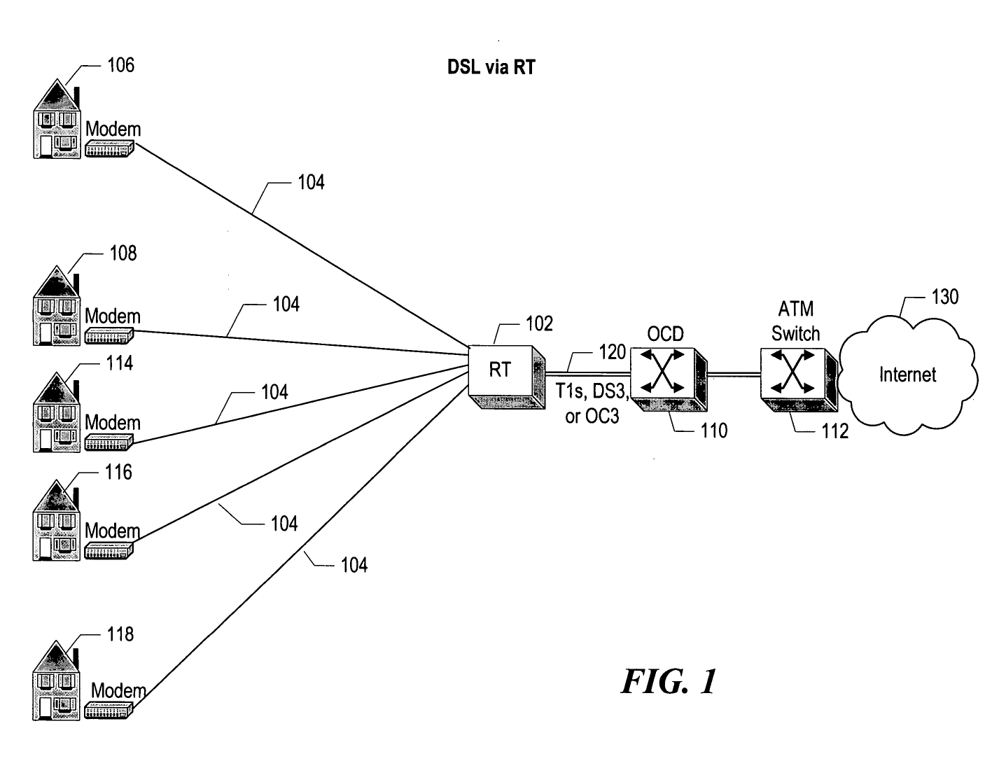

Referring to FIG. 1, an illustrative communication system that includes DSL lines and backend data switches is shown. The system includes a remote terminal (RT) 102 connected remotely from an optical concentrator device (OCD) 110 via communication lines 120. The communication lines 120 may be T1 lines, DS3 lines, or OC3 lines as shown. The OCD 110 is coupled to an ATM switch 112, which in turn is connected to the internet 130. The remote terminal 102 supports a plurality of digital subscriber lines (DSL) 104 which are coupled to customer premise equipment at subscriber locations. Sample subscribers are illustrated as units 106, 108, 114, 116, and 118. An example of customer premises equipment includes a DSL modem as shown. Data received by the remote terminal 102 from the plurality of DSL lines 104 is concentrated and carried over the communication line 120 to the concentration device 110. Data is extracted from the concentration device and communicated in an asynchronous transfer mode (ATM) format to the ATM switch 112. Data in packet form is then carried over the internet 130. With the system shown with respect to FIG. 1, the number of DSL lines 104 that may be supported by a given remote terminal 102 needs to be determined prior to configuration to avoid overloading of the system. Thus, it would be desirable prior to configuration to determine the appropriate number of DSL lines that may be supported by the RT 102.

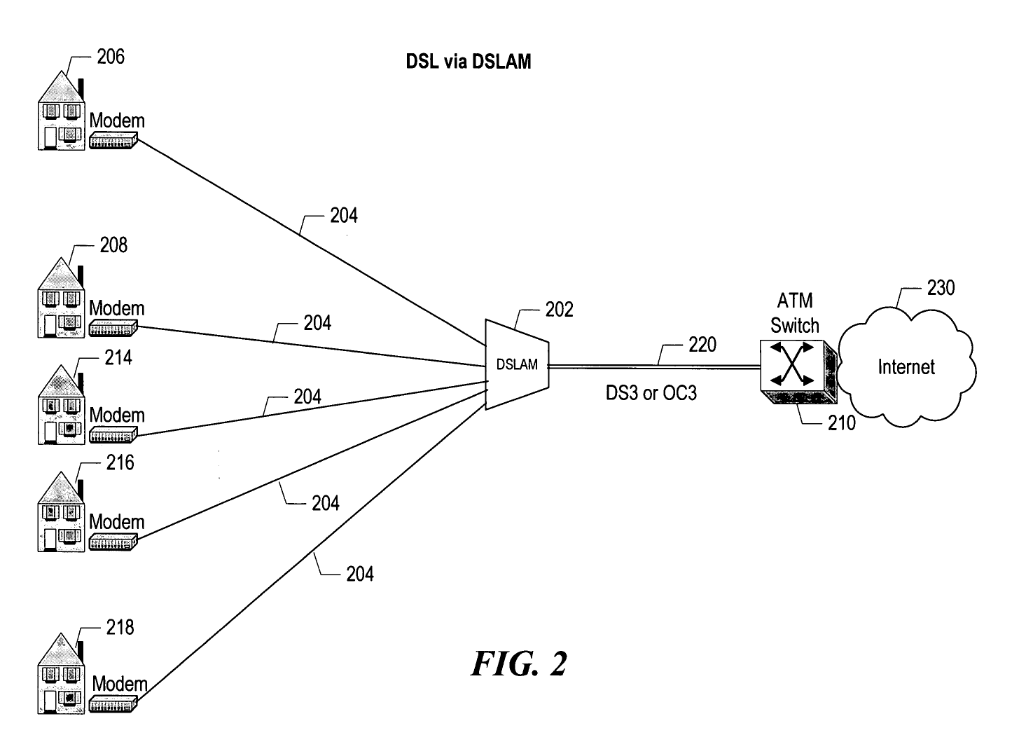

Referring to FIG. 2, another example communication system that supports DSL lines and backend data traffic is shown. The system includes a plurality of DSL lines 204 supported by a digital subscriber line access multiplexer 202 (DSLAM). The DSLAM 202 is connected to ATM switch 210 via the communication link 220. An example of the communication link 220 is a DS3 or OC3 line. The ATM switch 210 is connected to the internet 230. The DSL lines 204 are connected to customer premise equipment at various subscriber locations as shown at 206, 208, 214, 216, 218. Prior to configuration of the DSL lines 204, it would be useful to determine an appropriate number of DSL lines that may be supported by the specific DSLAM 202. Information regarding the appropriate number of DSL lines may be used for system configuration.

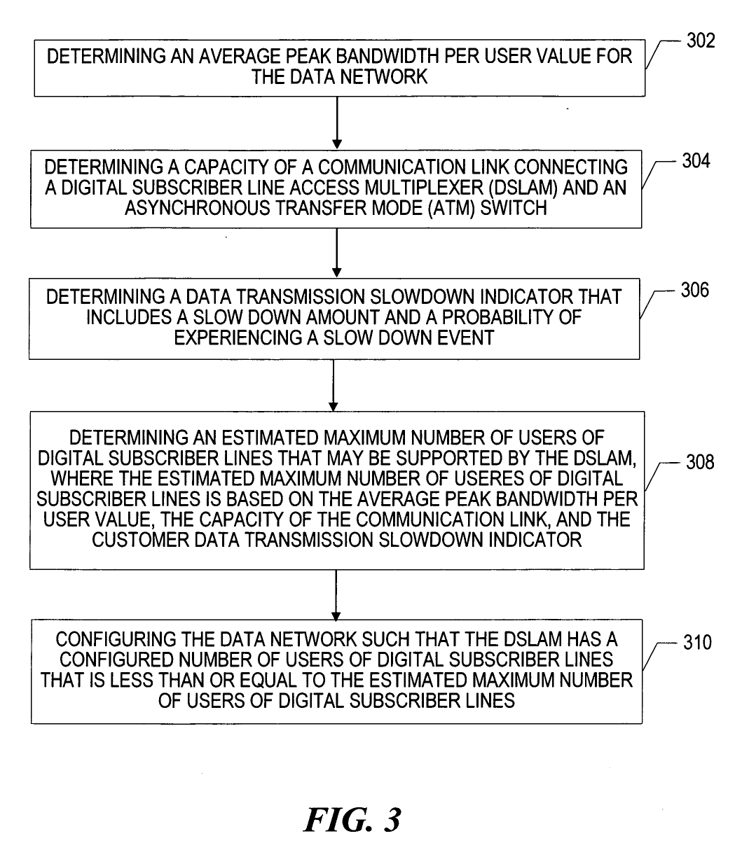

Referring to FIG. 3, a method of configuring a data network is illustrated. An average peak bandwidth is determined on a per user basis for the data network, as shown at 302. A capacity of a communication link is determined, at 304. The capacity of the communication link is for a DSLAM and a corresponding asynchronous mode (ATM) switch. A data transmission slowdown indicator is determined that includes a slowdown amount and a probability of experiencing a slowdown event, as shown at 306.

Based on the prior information, an estimated maximum number of users is determined corresponding with a maximum number of DSL lines that may be supported by the DSLAM, is shown at 308. The estimated maximum number of users of DSL lines is based on the average peak bandwidth per user value, the bandwidth capacity of a user, the capacity of the communication link, and the customer data transmission slowdown indicator. Once an estimated maximum number of users of DSL lines is determined, the data network may be configured such that the DSLAM has a configured number of users of DSL lines that is less than or equal to the estimated maximum number of users of DSL lines. This process step is shown at 310. Thus, after determining the estimated maximum number of DSL lines, DSLAM equipment may be configured to prevent overuse and traffic congestion of the DSL network. In addition, the DSLAM may be properly loaded to provide for increased traffic utilization, but not exceeding the estimated maximum number of lines.

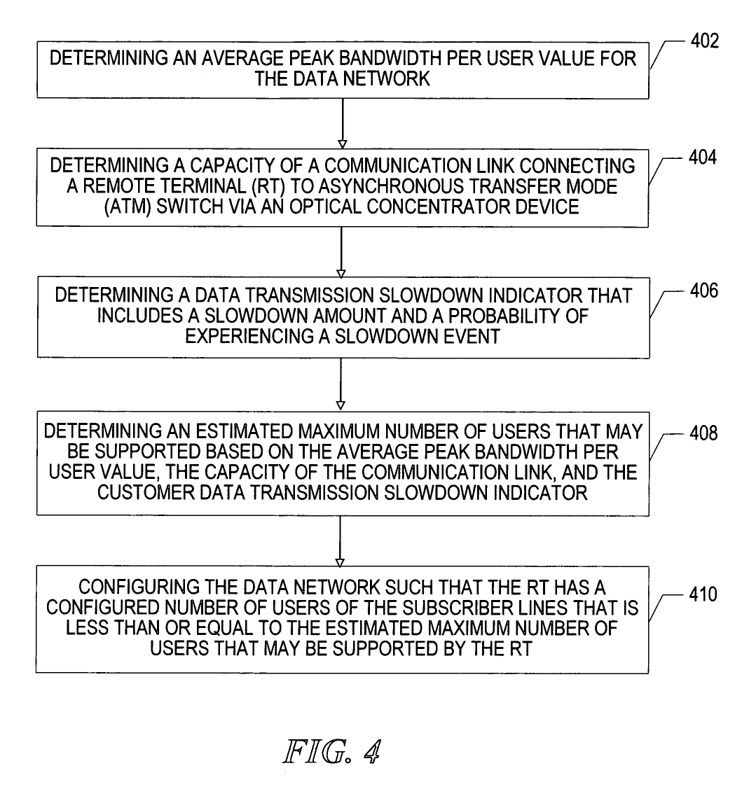

Referring to FIG. 4, another method of configuring a data network is illustrated. An average peak bandwidth per user value is determined for the data network, at 402. A capacity of a communication link that connects a remote terminal (RT) to the ATM switch via an optical concentrator device is determined, at 404. A data transmission slowdown indicator is determined, at 406. The data transmission slowdown indicator includes a slowdown amount and a probability of experiencing a slowdown event that would cause a slowdown. Based on the average peak bandwidth per user value, the bandwidth capacity of a user, the capacity of the communication link, and the customer data transmission slowdown indicator, an estimated maximum number of users that may be supported by the remote terminal (RT) is determined, at 408. Once the estimated maximum number of users that may be supported by the RT is determined, the data network is configured such that the RT has a configured number of users that is less than or equal to the estimated maximum number of users. The data configuration step is shown at 410.

An example of an estimated maximum capacity model that may be used to calculate the estimated maximum capacity is now shown. For purposes of illustration, the bandwidth capacity of a remote terminal will be illustrated as the bandwidth B. The capacity of an individual user, which is the highest data transmission speed available to that user, will be labeled C. Typically, this individual user download speed for a DSL line is about 1.5 megabits per second. The average peak period bandwidth per customer will be indicated as A. This value is averaged over all customers in the network even those that are not currently logged in.

The number of servers will be determined as B/C. The total number of customers on an RT will be labeled PS for population size. The probability of a random user downloading at any given instant will be labeled U and is defined as A/C. A probability distribution labeled P is calculated as U/(1−U). This is substantially the same calculation utilized for telephone circuits based on an Erlang engineering distribution. P(n) is the probability of n customers actively downloading in a randomly chosen time.

With these variable definitions, the model formula is defined below:

$$\begin{matrix}F ( 0 ) = 1. & \\ F ( n ) = ρ * F ( n - 1 ) * ( P - ( n - 1 ) ) / n & for n < S . \\ F ( n ) = ρ * F ( n - 1 ) * ( P - ( n - 1 ) ) / S & for S <= n <= PS \\ 0 & for n > PS \\ p ( 0 ) = 1 / {\sum }_{n = 0}^{PS} F ( n ) . & \\ p ( n ) = F ( n ) * p ( 0 ) . & \end{matrix}$$

A specific example with specific data filled in for a given remote terminal is now presented:

A rural RT is served by 2 T1 lines and has 20 customers all with a maximum download speed of 1.5 Mb/s and an average peak bandwidth of 50 kb/sec.

| | |
|---|---|
| B | 3072 |
| C | 1536 |
| A | 50 |
| S | 2 |
| PS | 20 |
| U | 0.0326 |
| D | 0.0336 |

| | | | |
|---|---|---|---|
| F(0) = | 1 | p(0) = | 50.54% |
| F(1) = | 0.672948 | p(1) = | 34.01% |
| F(2) = | 0.215108 | p(2) = | 10.87% |
| F(3) = | 0.065140 | p(3) = | 3.29% |
| F(4) = | 0.018630 | p(4) = | 0.94% |
| F(5) = | 0.005015 | p(5) = | 0.25% |
| F(6) = | 0.001266 | p(6) = | 0.06% |
| F(7) = | 0.000298 | p(7) = | 0.02% |
| F(8) = | 0.000065 | p(8) = | 0.00% |
| F(9) = | 0.000013 | p(9) = | 0.00% |
| F(10) = | 0.000002 | p(10) = | 0.00% |
| F(11) = | 0.000000 | p(11) = | 0.00% |
| F(12) = | 0.000000 | p(12) = | 0.00% |
| F(13) = | 0.000000 | p(13) = | 0.00% |
| F(14) = | 0.000000 | p(14) = | 0.00% |
| F(15) = | 0.000000 | p(15) = | 0.00% |
| F(16) = | 0.000000 | p(16) = | 0.00% |
| F(17) = | 0.000000 | p(17) = | 0.00% |
| F(18) = | 0.000000 | p(18) = | 0.00% |
| F(19) = | 0.000000 | p(19) = | 0.00% |
| F(20) = | 0.000000 | p(20) = | 0.00% |
| Sum | 1.978486 | Sum | 100.00% |

One way to engineer the RT is to ensure that customers experience a slowdown of no more than, say, 20%, no more than X % of the time. The tables below show the results for this example with X=1%, 5%, and 10%.

Probability of Slowdown in the Peak Period less than 1%.

Ave Peak Period BW/Cust. in Kb/sec

| # of T1s | 30 | 40 | 60 | 100 |
|---|---|---|---|---|
| 1 | 5 | 4 | 3 | 2 |
| 2 | 19 | 15 | 10 | 6 |
| 3 | 39 | 29 | 20 | 12 |
| 4 | 62 | 47 | 31 | 19 |
| 5 | 87 | 66 | 44 | 27 |
| 6 | 135 | 102 | 69 | 42 |
| 7 | 166 | 125 | 84 | 51 |
| 8 | 197 | 149 | 100 | 61 |

Probability of Slowdown in the Peak Period less than 5%.

Ave Peak Period BW/Cust. in Kb/sec

| # of T1s | 30 | 40 | 60 | 100 |
|---|---|---|---|---|
| 1 | 12 | 9 | 6 | 4 |
| 2 | 33 | 25 | 17 | 10 |
| 3 | 60 | 45 | 30 | 19 |
| 4 | 90 | 58 | 45 | 28 |
| 5 | 122 | 92 | 62 | 37 |
| 6 | 176 | 132 | 89 | 54 |
| 7 | 211 | 159 | 107 | 65 |
| 8 | 248 | 187 | 125 | 76 |

Probability of Slowdown in the Peak Period less than 10%.

Ave Peak Period BW/Cust. in Kb/sec

| # of T1s | 30 | 40 | 60 | 100 |
|---|---|---|---|---|
| 1 | 17 | 12 | 8 | 5 |
| 2 | 43 | 32 | 22 | 13 |
| 3 | 74 | 56 | 37 | 23 |
| 4 | 107 | 81 | 54 | 33 |
| 5 | 143 | 107 | 72 | 44 |
| 6 | 198 | 149 | 100 | 61 |
| 7 | 237 | 178 | 120 | 73 |
| 8 | 276 | 208 | 139 | 85 |

In another embodiment, a method of estimation is provided that does not assume all customers have the same bandwith. In this method customers can have different bandwith speeds. For DSL, the bandwith speeds are integer multiples of the slowest speed. Below is an illustration:
B—The bandwidth capacity of an RT or DSLAM (referred to as RT hereafter) is the size of the “pipe” connecting the RT to the OCD. Typically, this will be a DS3 or an OC3, but may be a set of T1s in a rural RT setup.
Cᵢ—Capacity of type i users. This is the highest download speed available to that user. This is considered constant for all type i users and must be an integer multiple of the Cᵢ.
Aᵢ—Average peak period bandwidth per customer for type i users. This is averaged over all type i customers, not just customers currently logged on.
S—Number of servers=B/C₁ (e.g., for a single DS3 with C₁=1536, this is 43,008/1,536=28). This must be rounded to an integer.
Rᵢ—Ratio of Cᵢ/C₁.
Pᵢ—Total number of type i customers on the RT.
Uᵢ—Probability of a random type i user downloading at any instant=Aᵢ/Cᵢ.
ρᵢ—Rho=Uᵢ/(1−Uᵢ) (this is equivalent to λ/μ in an Erlang or Engset distribution).
k—number of different types of customers.
p(n₁, n₂ . . . nₖ)—probability of n₁ customers of type 1 and n₂ customers of type 2, . . . nₖ customers of type k actively downloading at any randomly chosen time in the peak period.
The model works like this:

$$\begin{matrix}F ( 0 , 0 , … , 0 ) = 1. & \\ F ( {n}_{1} , … , {n}_{j} , … , {n}_{k} ) = {ρ}_{j} * F ( {n}_{1} , … , {n}_{j - 1} , … , {n}_{k} ) * ( {P}_{j} - ( {n}_{j} - 1 ) ) / n & for {\sum }_{i = 1}^{k} {n}_{i} * {R}_{i} < S . \\ F ( {n}_{1} , … , {n}_{j} , … , {n}_{k} ) = {ρ}_{j} * F ( {n}_{1} , … , {n}_{j - 1} , … , {n}_{k} ) * ( {P}_{j} - ( {n}_{j} - 1 ) ) / S & for S <= {\sum }_{i = 1}^{k} {n}_{i} * {R}_{i} and {n}_{j} <= {P}_{j} . \\ F ( {n}_{1} , … , {n}_{j} , … , {n}_{k} ) = 0 & for {n}_{j} > {P}_{j} .\end{matrix}$$

$$p ( 0 , … 0 ) = 1 / Σ F ( {n}_{1} , … , {n}_{j} , … , {n}_{k} ) . Where the sum is over all values of ( {n}_{1} , … , {n}_{j} , … , {n}_{k} ) . \\ p ( {n}_{1} , … , {n}_{j} , … , {n}_{k} ) = F ( {n}_{1} , … , {n}_{j} , … , {n}_{k} ) * p ( 0 , … 0 ) .$$

### EXAMPLE

A rural RT is served by 4 T1 lines and has 15 customers with a maximum download speed of L536M and an average peak bandwidth of 50 kb/sec and 5 customers with a maximum download speed of 6.144M and an average peak bandwidth of 100 kb/sec.

| | |
|---|---|
| B | 6144 |
| S | 4 |

| | Type 1 | Type 2 |
|---|---|---|
| C | 1536 | 6144 |
| A | 50 | 100 |
| P | 15 | 5 |
| U | 0.0326 | 0.0163 |
| P | 0.0336 | 0.0165 |

| Type I | Type 2 Customers | | | | | |
|---|---|---|---|---|---|---|
| Customers | 0 | 1 | 2 | 3 | 4 | 5 |

F(type1, type2)

| | | | | | | |
|---|---|---|---|---|---|---|
| 0 | 1.000000 | 0.082727 | 0.005475 | 0.000272 | 0.000009 | 0.000000 |
| 1 | 0.504711 | 0.052191 | 0.003886 | 0.000209 | 0.000007 | 0.000000 |
| 2 | 0.118875 | 0.014751 | 0.001220 | 0.000071 | 0.000003 | 0.000000 |
| 3 | 0.017333 | 0.002509 | 0.000228 | 0.000014 | 0.000001 | 0.000000 |
| 4 | 0.001750 | 0.000289 | 0.000029 | 0.000002 | 0.000000 | 0.000000 |
| 5 | 0.000162 | 0.000030 | 0.000003 | 0.000000 | 0.000000 | 0.000000 |
| 6 | 0.000014 | 0.000003 | 0.000000 | 0.000000 | 0.000000 | 0.000000 |
| 7 | 0.000001 | 0.000000 | 0.000000 | 0.000000 | 0.000000 | 0.000000 |
| 8 | 0.000000 | 0.000000 | 0.000000 | 0.000000 | 0.000000 | 0.000000 |
| 9 | 0.000000 | 0.000000 | 0.000000 | 0.000000 | 0.000000 | 0.000000 |
| 10 | 0.000000 | 0.000000 | 0.000000 | 0.000000 | 0.000000 | 0.000000 |
| 11 | 0.000000 | 0.000000 | 0.000000 | 0.000000 | 0.000000 | 0.000000 |
| 12 | 0.000000 | 0.000000 | 0.000000 | 0.000000 | 0.000000 | 0.000000 |
| 13 | 0.000000 | 0.000000 | 0.000000 | 0.000000 | 0.000000 | 0.000000 |
| 14 | 0.000000 | 0.000000 | 0.000000 | 0.000000 | 0.000000 | 0.000000 |
| 15 | 0.000000 | 0.000000 | 0.000000 | 0.000000 | 0.000000 | 0.000000 |

p(type1, type2)

| | | | | | | |
|---|---|---|---|---|---|---|
| 0 | 55.35% | 4.58% | 0.30% | 0.02% | 0.00% | 0.00% |
| 1 | 27.93% | 2.89% | 0.22% | 0.01% | 0.00% | 0.00% |
| 2 | 6.58% | 0.82% | 0.07% | 0.00% | 0.00% | 0.00% |
| 3 | 0.96% | 0.14% | 0.01% | 0.00% | 0.00% | 0.00% |
| 4 | 0.10% | 0.02% | 0.00% | 0.00% | 0.00% | 0.00% |
| 5 | 0.01% | 0.00% | 0.00% | 0.00% | 0.00% | 0.00% |
| 6 | 0.00% | 0.00% | 0.00% | 0.00% | 0.00% | 0.00% |
| 7 | 0.00% | 0.00% | 0.00% | 0.00% | 0.00% | 0.00% |
| 8 | 0.00% | 0.00% | 0.00% | 0.00% | 0.00% | 0.00% |
| 9 | 0.00% | 0.00% | 0.00% | 0.00% | 0.00% | 0.00% |
| 10 | 0.00% | 0.00% | 0.00% | 0.00% | 0.00% | 0.00% |
| 11 | 0.00% | 0.00% | 0.00% | 0.00% | 0.00% | 0.00% |
| 12 | 0.00% | 0.00% | 0.00% | 0.00% | 0.00% | 0.00% |
| 13 | 0.00% | 0.00% | 0.00% | 0.00% | 0.00% | 0.00% |
| 14 | 0.00% | 0.00% | 0.00% | 0.00% | 0.00% | 0.00% |
| 15 | 0.00% | 0.00% | 0.00% | 0.00% | 0.00% | 0.00% |

This model allows different types of customers to have different bandwidth speeds and also for different types of customers to have different average peak period bandwidth. This allows capacity questions to be analyzed under more realistic conditions than previously available. For example, 6 Mb/s links can use up the capacity of RTs that have only a few T1s of total capacity. Therefore, being able to accurately analyze the impact of adding these customers to 1.5 Mb/s customers is important in setting capacity. Also, one might want to assume that the 6 Mb/s customers have a different average peak period bandwidth when analyzing even large capacity DSLAMs and RTs.

An example of how this model can be used in practice follows: Suppose type 1 customers have 1.5 Mb/s capacity and an average peak period bandwidth of 20 kb/sec. Type 2 customers have 6 Mb/s capacity and an average bandwidth of 35 kb/sec. If we estimate that the type 2 customers will be 10% of the total customer base, the model as described can be used to calculate the capacity of an RT in the following way. With this assumption, 90% of the customers are assumed to be type 1 customers. The probability of slowdown of at least x % is calculated for some (0.9*N) type 1 customers and (0.1*N) type 2 customers. N is increased or decreased until the largest value of N is found where the probability of slowdown is at least x % less than a desired threshold. One can also vary the percentage of type 2 customers, repeat the process, and observe the impact of the percentage of type 2 customers on the capacity of the RT.

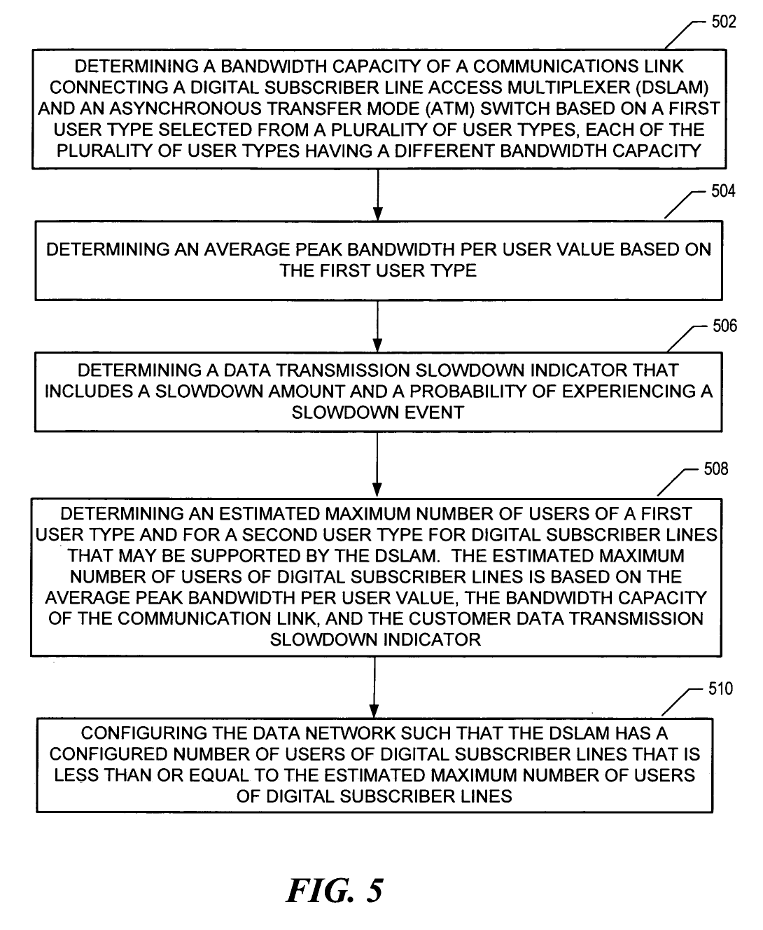

Referring to FIG. 5, a method of estimating capacity is disclosed. A bandwidth capacity of a communications link that connects a DSLAM and an ATM switch is determined, at 502. The estimated capacity is based on a first user type that is selected from a set of available user types. Each of the set of user types has a different and constant assumed bandwidth. For example, a first user type may have a bandwidth of 1.5 MB/s and a second user type may have a bandwidth of 6 Mb/s. An average peak bandwidth per user value is determined based on the first user type, at 504. While the first user type is described, it should be understood that a second, third or any particular number of user types may be defined and selected depending on the particular implementation and network. A data transmission slowdown indicator is determined at 506. The slowdown indicator includes a slowdown amount and an estimated possibility of experiencing a slowdown event. Based on the average peak bandwidth per user value, the bandwidth capacity of the link, and the transmission slowdown indicator for the particular customer with the selected user type, an estimated maximum number of users of a first user type and for a second user type of DSL lines is determined, at 508. The above described formulas and computation methods may be used to determine this estimated maximum number of users for different user types. At 510, a data network is configured such that the DSLAMs in the network support a number of DSL user that is less than or equal to the estimated maximum number of users.

The above disclosed methods and models provide an improved estimate for the number of customers that may be served by a given capacity communication link. This estimate is useful for configuration of data networks as illustrated. The methods may be implemented by use of a spreadsheet program on a personal computer. In addition, the models have wide applicability and may be useful for telecommunications providers to determine the amount of bandwidth needed to provide a given service. Similarly, suppliers of switching equipment may use the models to assist their customers to properly size deployed networks.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
an asynchronous transfer mode (ATM) switch responsive to a network; and
a digital subscriber line access multiplexer (DSLAM) coupled to the ATM switch and to a plurality of digital subscriber lines, the DSLAM to support the plurality of digital subscriber lines, the DSLAM configurable to limit a number of supported digital subscriber lines based on an estimated capacity model, the estimated capacity model including a data transmission slowdown indicator comprising a probability of experiencing a slowdown event.

2. The system of claim 1, wherein the slowdown indicator further comprises an estimated slowdown amount.

3. The system of claim 1, wherein the estimated capacity model defines a maximum number of supported digital subscriber lines.

4. The system of claim 1, wherein the capacity model further comprises an estimated bandwidth usage based on an average peak period bandwidth for a plurality of customers.

5. The system of claim 4, wherein the average peak period bandwidth for each of the plurality of customers is approximately equal.

6. The system of claim 4, wherein each customer of the plurality of customers is assigned an associated average peak period bandwidth related to an estimated usage by the customer.

7. The system of claim 6, wherein a first average peak period bandwidth of a first customer of the plurality of customers is different from a second average peak period bandwidth of a second customer of the plurality of customers.

8. A method comprising:
selecting a first user type and a second user type from a set of available user types, each user type of the set of available user types including an associated constant bandwidth, wherein a first bandwidth of the first user type is different from a second bandwidth of the second user type;
determining a first average peak bandwidth based on the first user type and a second average peak bandwidth based on the second user type;
estimating a first percentage of customers comprising the first user type and a second percentage of customers comprising the second user type;
determining probability of slowdowns associated with the first percentage and associated with the second percentage; and
estimating a number of users of the first type and the second type at least partially based on the probability of slowdowns and an average peak bandwidth per user type.

9. The method of claim 8, further comprising:
selecting a third user type having a third constant bandwidth;
determining a third average peak bandwidth based on the third user type;
estimating the third percentage of customers comprising the third user type; and
determining a probability of slowdown based on the third percentage.

10. The method of claim 8, wherein estimating a number of users comprises:
adjusting the number of users such that a product of the number of users multiplied by a sum of the probability of slowdown of each user type is below a predetermined threshold.

11. The method of claim 10, wherein the predetermined threshold comprises a percentage less than approximately 20%.

12. The method of claim 8, wherein the first user type comprises a 6 Mb/s user type.

13. The method of claim 8, wherein the first user type has an average bandwidth of 35 kb/sec.

14. The method of claim 8, wherein the second user type comprises a 1.5 Mb/s user type.

15. The method of claim 13, wherein the second user type has an average peak bandwidth of 20 kb/sec.

16. A method comprising:
selecting a population of user types, each user type of the population of user types including an average bandwidth parameter;
determining a slowdown indicator including a slowdown amount and a probability of a slowdown event for each user type;
estimating a maximum number of users of the selected population of user types according to the average bandwidth parameter and the slowdown indicator for each user type; and
configuring a device to limit a number of supported digital subscriber lines to a number that is less than the maximum number.

17. The method of claim 16, wherein selecting the population of user types comprises:
determining a percentage associated with each user type of a set of user types based on an estimated composition of the population of user types.

18. The method of claim 17, wherein the percentage of a first user type of the set of user types comprises approximately 10% of the population of user types.

19. The method of claim 16, wherein configuring a device comprises configuring a digital subscriber line access multiplexer (DSLAM) to support a number of digital subscriber lines that is less than the estimated maximum number of users.

20. The method of claim 16, wherein the population of user types comprises a first user type having a first average bandwidth parameter and a second user type having a second average bandwidth parameter, wherein the first average bandwidth parameter is greater than the second average bandwidth parameter.
